(19) United States
(12) Patent Application Publication
(10) Pub. No.: US 2003/0231244 A1
(43) Pub. Date: Dec. 18, 2003

(54) Method and system for manipulating a field of view of a video image from a remote vehicle

(76) Inventors: Victor G. Bonilla, Scottsdale, AZ (US); James W. McCabe, Scottsdale, AZ (US)

Correspondence Address: Brian C. Kunzler, Suite 425, 10 West 100 South, Salt Lake City, UT, 84101, US

(21) Appl. No.: 10/421,663

(22) Filed: Apr. 22, 2003

Related U.S. Application Data
(60) Provisional application No. 60/374,440, filed on Apr. 22, 2002.

(51) Int. Cl. H04N 5/232

(52) U.S. Cl. 348/211.2

(57) ABSTRACT

A method and system for manipulating a field of view of a video image from a remote vehicle allow a spectator to issue a field of view command specifying a desired field of view. The method and system are configured to modify the video image to conform to the field of view command. The method and system may modify the video image by manipulating a video camera. The method and system may also modify the video image by composing the desired field of view image from one or more concurrently generated video images.

### BACKGROUND OF THE INVENTION

1. The Field of the Invention

The invention relates to methods for manipulating a remote image. Specifically, the invention relates to methods and systems for manipulating an image field of view for a remote vehicle.

2. The Relevant Art

Racing enthusiasts enjoy viewing racing action from a variety of viewpoints. One of the most exciting viewpoints is the viewpoint of the driver of a vehicle. Video cameras have been mounted in vehicles to provide a remote spectator a video image of racing action from the driver's viewpoint. However, current methods and systems for providing a video image from a racing vehicle diminish the experience. The spectator is restricted to a fixed field of view. Critical views such as to the rear or to the sides of the vehicle are often not available. The spectator does not have the option of viewing other action outside the fixed field of view, reducing the racing experience. Thus the spectator cannot participate in much of the drama, strategy, or excitement of viewing a race from the driver's point of view.

Racing is a 360° experience. Important action takes place all around vehicle. Limiting a video image to a fixed or predetermined viewpoint limits the value of the experience. Providing a spectator with the capability to view all aspects of a racing situation enhances the experience for the remote spectator.

What is needed is a method and system for manipulating a video image of a field of view for a remote vehicle. Such a method and system preferably would allow a spectator to determine the field of view of a video image from a racing vehicle. Additionally, the method and system may also allow multiple spectators to determine independent fields of view from a video image.

### SUMMARY OF THE INVENTION

The various elements of the present invention have been developed in response to the present state of the art, and in particular, in response to the problems and needs in the art that have not yet been fully solved by currently available remote controlled vehicles. More particularly, various elements of the present invention have been developed in response to the present state of the art and in response to the problems and needs in the art that have not yet been fully solved by currently available remote control vehicle control vision systems. Accordingly, the present invention provides an improved method, and system for manipulating a video image field of view from a racing vehicle.

In accordance with the invention as embodied and broadly described herein in the preferred embodiments, an improved remote control vehicle is provided and configured to move in a direction selectable remotely by a user. The vehicle comprises a chassis configured to move about in response to vehicle control data from a user; a controller residing within the chassis configured to receive network switched packets containing the vehicle control data; and an actuator interface module configured to operate an actuator in response to the vehicle control data received by the controller. The controller is configured to transmit vehicle data feedback to a user. Additionally, the controller may comprise a wireless network interface connection configured to transmit and receive network switched packets containing vehicle control data.

The present invention comprises a method of controlling a vehicle over a digital data network, including but not limited to a LAN, WAN, satellite, and digital cable networks. The method comprises providing a mobile vehicle configured to transmit and receive vehicle control data over the network, providing a central server configured to transmit and receive vehicle control data, transmitting vehicle control data, controlling the mobile vehicle in response to the transmitted vehicle control data, and receiving vehicle feedback data from the vehicle. Transmitting vehicle control data may comprise transmitting network switched packets in a peer-to-peer environment or in an infrastructure environment.

In one aspect of the present invention, a method for manipulating a field of view from a remote vehicle is presented. A spectator transmits a field of view command specifying a desired field of view for a video image from a racing vehicle. The field of view command manipulates a video camera mounted in a vehicle to capture the desired field of view. In one embodiment, the method allows a spectator to manipulate the field of view of a video camera through a 360° visual space of a remote field of action.

In an alternate aspect of the present invention, a method for manipulating multiple fields of view from a remote vehicle is presented. The method captures a video image from a video camera mounted in a remote vehicle. A spectator transmits a field of view command specifying a desired field of view. The method composes a field of view image corresponding to the desired field of view. In one embodiment, the method composes multiple independent field of view images according to multiple, independent field of view commands.

Various elements of the present invention are combined into a system for manipulating a video image for a remote vehicle. The system uses a video camera mounted in a remote vehicle to capture a video image. A spectator transmits a field of view command to the system specifying a desired field of view. The system manipulates the video camera field of view to conform to the desired field of view. The system transmits the desired field of view image to the spectator.

The present invention facilitates selecting a desired field of view image for a remote vehicle. The present invention further provides for multiple spectators to independently select multiple desired field of view images. The various elements and aspects of the present invention provide an enhanced viewing experience for a spectator viewing a video image from a remote vehicle. These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of one embodiment of a network controlled vehicle of the present invention;

FIG. 2 is a block diagram illustrating one embodiment of a vehicle control module of the present invention;

FIG. 3 is a schematic top view diagram illustrating one embodiment a vehicle/video camera of the prior art;

FIG. 4 is a schematic top view diagram illustrating one embodiment of a vehicle/manipulatable video camera system of the present invention;

FIG. 5 is a flow chart illustrating one embodiment of a field of view manipulation method of the present invention;

FIG. 6 is a block diagram illustrating one embodiment of a field of view manipulation system of the present invention;

FIG. 7 is a schematic top view diagram illustrating one embodiment of a vehicle/multiple video camera system of the present invention;

FIG. 8 is flow chart illustrating one embodiment of a multiple field of view manipulation method of the present invention; and

FIG. 9 is a block diagram illustrating one embodiment of a field of view manipulation system of the present invention.

### DETAILED DESCRIPTION OF THE PREFERRED EMBODIMENTS

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

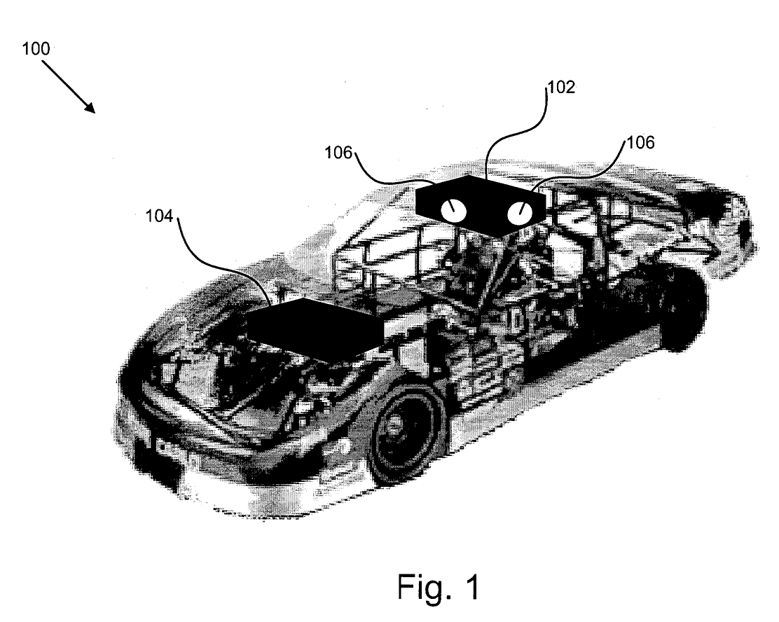

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. FIG. 1 shows a vehicle 100 that is controllable over a network. As depicted, the vehicle 100 comprises a video camera module 102 and a vehicle control module 104. The vehicle 100 is in one embodiment replicated at one-quarter scale, but may be of other scales also, including one-tenth scale, one-fifth scale, and one-third scale. Additionally, the network controlled vehicle 100 may embody scaled versions of airplanes, monster trucks, motorcycles, boats, buggies, and the like. In one embodiment, the vehicle 100 is a standard quarter scale vehicle 100 with centrifugal clutches and gasoline engines, and all of the data for the controls and sensors are communicated across the local area network. Alternatively, the vehicle 100 may be electric or liquid propane or otherwise powered. Quarter scale racecars are available from New Era Models of Nashua, NH as well as from other vendors, such as Danny's ¼ Scale Cars of Glendale, Ariz.

The vehicle 100 is operated by remote control, and in one embodiment an operator need not be able to see the vehicle 100 to operate it. Rather, a video camera module 102 is provided with a one or more cameras 106 connected to the vehicle control module 104 for displaying the points of view of the vehicle 100 to an operator. The operator may control the vehicle 100 from a remote location at which the operator receives vehicle control data and optionally audio and streaming video. In one embodiment, the driver receives the vehicle control data over a local area network. Under a preferred embodiment of the present invention, the video camera module 102 is configured to communicate to the operator using the vehicle control module 104. Alternatively, the video camera module 102 may be configured to transmit streaming visual data directly to an operator station.

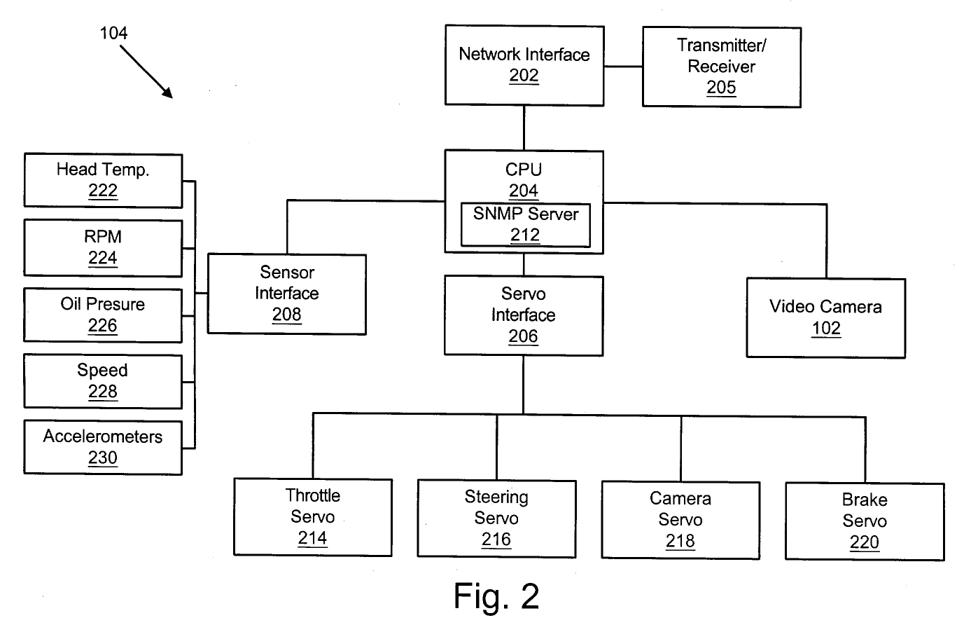

FIG. 2 is a block diagram showing one embodiment of the vehicle control module 104 of FIG. 1. The vehicle control module 104 preferably comprises a network interface module 202, a central processing unit (CPU) 204, a servo interface module 206, a sensor interface module 208, and the video camera module 102. In one embodiment, the network interface module 202 is provided with a wireless transmitter and receiver 205. The transmitter and receiver 205 may be custom designed or may be a standard, off-the-shelf component such as those found on laptops or electronic handheld devices. Indeed, a simplified computer similar to a Palm™ or Pocket PC™ may be provided with wireless networking capability, as is well known in the art and placed in the vehicle 100 for use as the vehicle control module 104.

In one embodiment of the present invention, the CPU 204 is configured to communicate with the servo interface module 206, the sensor interface module 208, and the video camera module 102 through a data channel 210. The various controls and sensors may be made to interface through any type of data channel 210 or communication ports, including PCMCIA ports. The CPU 204 may also be configured to select from a plurality of performance levels upon input from an administrator received over the network. Thus, an operator may use the same vehicle 100 and may progress from lower to higher performance levels. The affected vehicle performance may include steering sensitivity, acceleration, and top speed. This feature is especially efficacious in driver education and training applications. The CPU 204 may also provide a software failsafe with limitations to what an operator is allowed to do in controlling the vehicle 100.

In one embodiment, the CPU 204 comprises a Simple Network Management Protocol (SNMP) server module 212. SNMP provides an extensible solution with low computing overhead to managing multiple devices over a network. SNMP is well known to those skilled in the art. In an alternate embodiment not depicted, the CPU 204 may comprise a web-based protocol server module configured to implement a web-based protocol, such as Java™, for network data communications.

The SNMP server module 212 is configured to communicate vehicle control data to the servo interface module 206. The servo interface module 206 communicates the vehicle control data with the corresponding servo. For example, the network interface card 202 receives vehicle control data that indicates a new position for a throttle servo 214. The network interface card 202 communicates the vehicle control data to the CPU 204 which passes the data to the SNMP server 212. The SNMP server 212 receives the vehicle control data and routes the setting that is to be changed to the servo interface module 206. The servo interface module 206 then communicates a command to the throttle servo 214 to accelerate or decelerate.

The SNMP server 212 is also configured to control a plurality of servos through the servo interface module 206. Examples of servos that may be utilized depending upon the type of vehicle are the throttle servo 214, a steering servo 216, a camera servo 218, and a brake servo 220. Additionally, the SNMP server 212 may be configured to retrieve data by communicating with the sensor interface module 308. Examples of some desired sensors for a gas vehicle 100 are a head temperature sensor 222, a tachometer 224, an oil pressure sensor 226, a speedometer 228, and one or more accelerometers 230. In addition, other appropriate sensors and actuators can be controlled in a similar manner. Actuators specific to an airplane, boat, submarine, or robot may be controlled in this manner. For instance, the arms of a robot may be controlled remotely over the network.

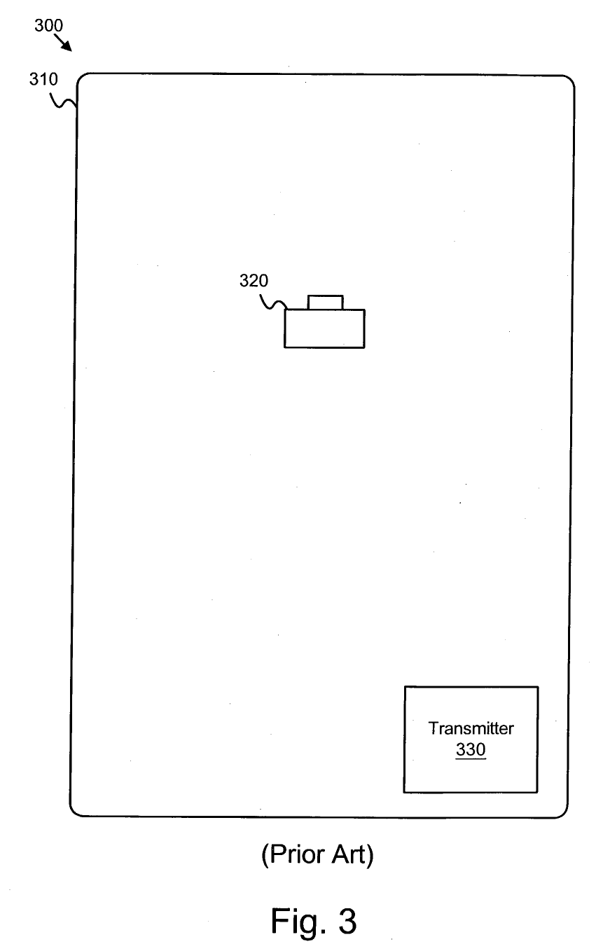

FIG. 3 is an illustration of one embodiment a vehicle/video camera of the prior art illustrates the limitations discussed in the background of the invention. The vehicle/video camera 300 includes a vehicle 310, a video camera 320, and a transmitter 330. The video camera 320 is mounted in the vehicle 310. The video camera 320 captures a video image. The transmitter 330 transmits the video image. The video camera 320 field of view is fixed.

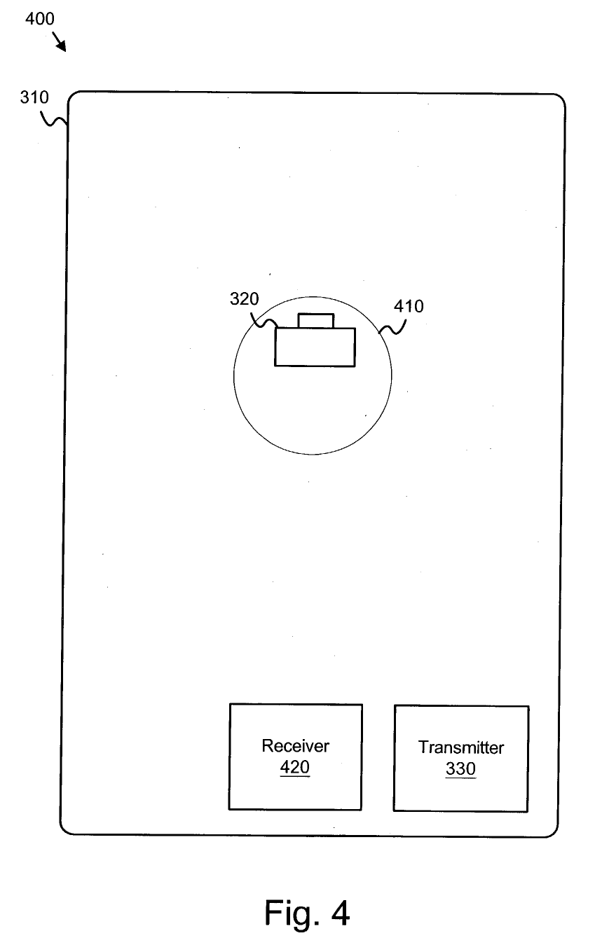

FIG. 4 is an illustration of one embodiment of a vehicle/manipulatable video camera system 400 of the present invention. The system 400 is allows the manipulation of a field of view of a video image from a remote vehicle. The system 400 includes a vehicle 310, a video camera 320, a video camera control module 410, a transmitter 330, and a receiver 420. The vehicle 320 may be controlled by a person within the vehicle or by remote control.

The video camera 320 is mounted to the video camera control module 410. The video camera control module 410 is mounted to the vehicle 310. The receiver 420 receives a field of view command. The field of view command specifies a desired field of view. The video camera control module 410 manipulates the video camera 320 to conform to the desired field of view. The video camera 320 captures a video image of the desired field of view. The transmitter 330 transmits the video image.

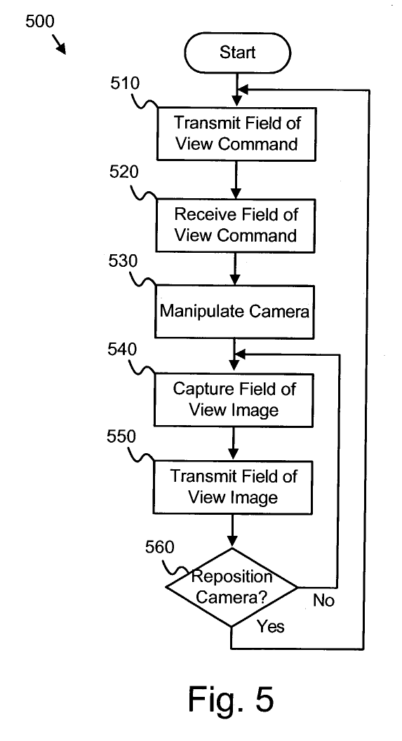

FIG. 5 is a flow chart illustrating one embodiment of a field of view manipulation method 500 of the present invention. The method 500 manipulates a field of view of a video image from a remote vehicle. The method 500 includes a transmit field of view command step 510, a receive field of view command step 520, a manipulate camera step 530, a capture field of view image step 540, a transmit field of view image step 550, and a reposition camera test 560.

The transmit field of view command step 510 transmits a field of view command from a user. The field of view command specifies a field of view desired by the user. The receive field of view command step 520 receives the field of view command at a receiver 420 mounted on a remote vehicle 310. The manipulate camera step 530 manipulates a video camera 320 mounted on the remote vehicle 310 in response to the field of view command. In response the field of view command, the video camera 320 conforms to the field of view specified by the field of view command.

The capture field of view image step 540 captures a field of view image with the video camera 320. The transmit field of view image step 550 transmits the field of view image from the remote vehicle 310 by way of a transmitter 330. The user may view the field of view image that conforms with the desired field of view. The reposition camera test 560 determines of a second field of view is desired by the user. If a second field of view is desired, the method 500 loops to the transmit field of view command step 510. If a second field of view is not desired, the method 500 loops to the capture field of view image step 540.

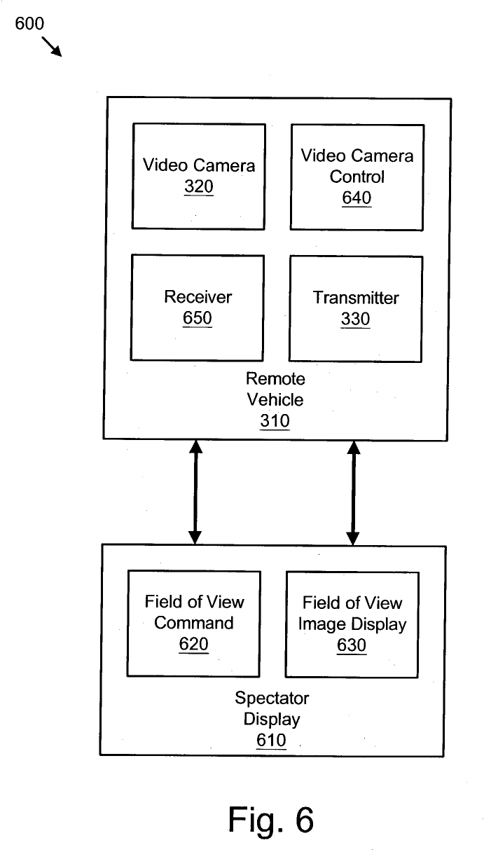

FIG. 6 is a block diagram illustrating one embodiment of a field of view manipulation system 600 of the present invention. The system 600 includes a remote vehicle 310 with a video camera 320, a transmitter 330, a video camera control module 640, and a receiver 650. The system further includes a spectator display 610 with a field of view command module 620 and a field of view image display module 630.

The spectator display 610 utilizes the field of view command module 620 to control a remote field of view. The field of view command module 620 issues a field of view command conforming to a desired field of view. The receiver 650 receives the field of view command. The video camera control module 640 manipulates the video camera 320 to conform to the field of view command. The video camera 320 captures a video image. The transmitter 330 transmits the video image. The image display module 630 displays the video image of the desired field of view.

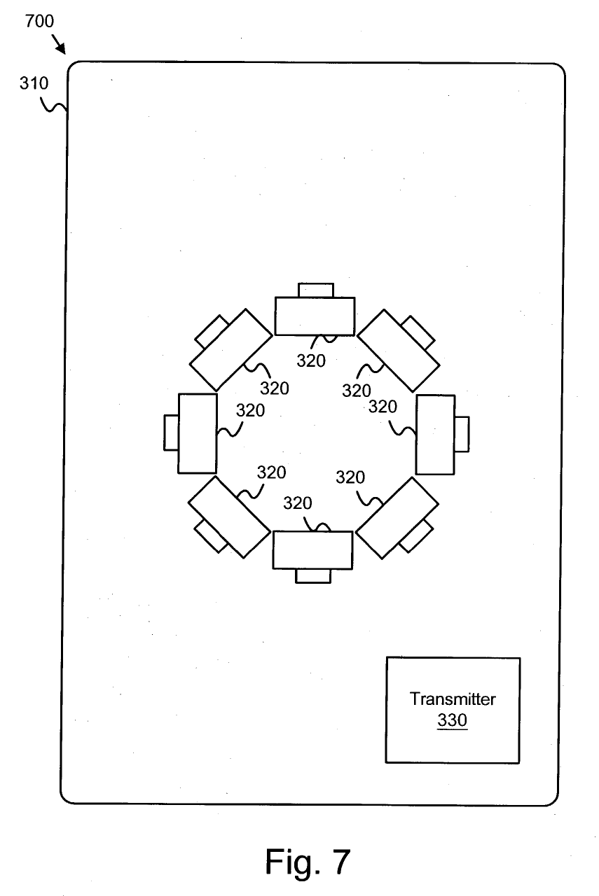

FIG. 7 is an illustration of one embodiment of a vehicle/multiple video camera system 700 of the present invention. The system 700 captures one or more video image field of view from a remote vehicle. The system 700 includes a vehicle 310, one or more video cameras 320, and a transmitter 330. Although for clarity purposes the system 700 is depicted with eight video cameras, any number of video cameras may be employed. The video cameras 320 are mounted in the vehicle 310. The video cameras 320 capture a plurality of video images. The transmitter 330 transmits the plurality of video images. A field of view image may be composed from one or more of the video images.

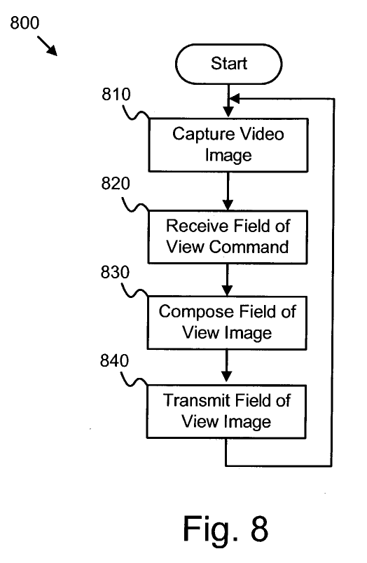

FIG. 8 is flow chart illustrating one embodiment of a multiple field of view manipulation method 800 of the present invention. The method manipulates a field of view image composed of one or more video images as described in FIG. 7. The method 800 includes a capture video image step 810, a receive field of view command step 820, a compose field of view image step 830, and a transmit field of view image step 840.

The capture video image step 810 captures a video image. In one embodiment, a plurality of video images are captured. The receive field of view command step 820 receives a field of view command. The field of view command specifies a desired field of view.

The compose field of view image step 830 composes a field of view image. The field of view image conforms to the desired field of view. Modifications to the field of view command may manipulate composition of the field of view image. In one embodiment, the field of view image is concatenated from one or more video images. The transmit field of view image step 840 transmits a field of view image. In one embodiment, the field of view image is transmitted via a network.

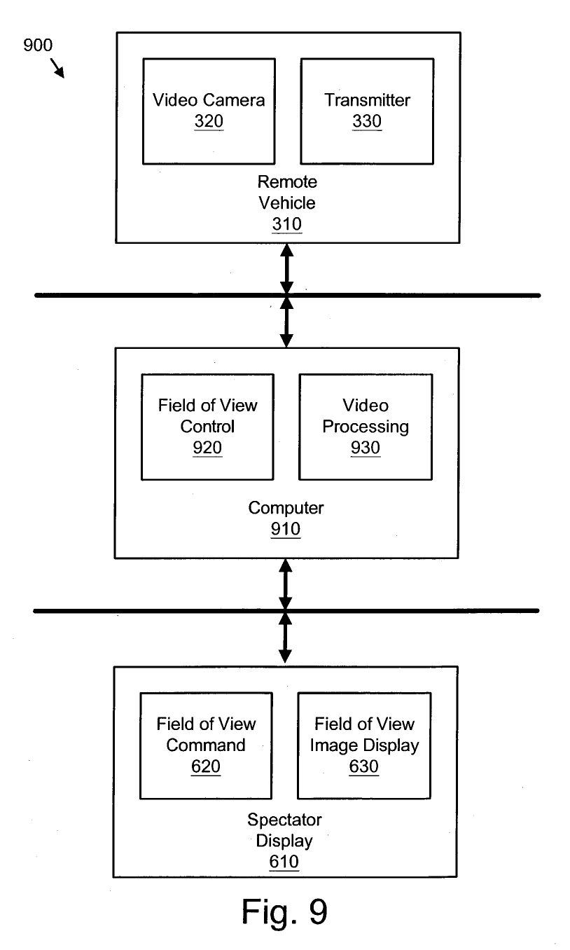

FIG. 9 is a block diagram illustrating one embodiment of a field of view manipulation system of the present invention. The system 900 includes a remote vehicle 310 with a video camera 320 and a transmitter 330. The system 900 further includes a computer 910 with a field of view control module 920 and a video processing module 930. The system also includes a spectator display 610 with a field of view command module 620 and a field of view image display 630.

The video camera 320 is mounted in the remote vehicle 310. The video camera 320 captures a video image. The transmitter 330 transmits the video image. The spectator display 610 interfaces with a spectator. The field of view command module 620 issues a field of view command. The field of view command specifies a desired field of view.

The computer 910 receives the video image. The computer 910 also receives the field of view command. The computer 910 field of view control module 920 identifies the desired field of view from the field of view command. The computer 910 video processing module 930 composes a field of view image. The field of view image conforms to the desired field of view of the field of view command. The video processing module 930 transmits the field of view image to the spectator display 610. The spectator display 610 field of view display 630 displays the field of view image.

The present invention permits a spectator to manipulate a field of view of a video image from a remote vehicle 310. The invention manipulates a video camera 320 field of view to provide a desired field of view. Allowing a spectator to manipulate the field of view enhances a racing cockpit viewing experience.

Additionally, the invention may be employed within a vehicle controlled by an occupant. For instance, under the invention, subscriptions or tickets may be sold to enthusiasts who wish to ride along with a pilot or driver of a vehicle. The enthusiast may transmit commands to alter the field of view over the Internet and receive the display of the selected field of view over the Internet. Thus, for example, Nascar™ fans could “ride along” with their favorite driver, and control the field of view from the race car.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for manipulating a field of view of a video image from a remote vehicle, the method comprising:
transmitting a field of view command;
receiving the field of view command;
manipulating a video camera field of view in accordance with the field of view command, the video camera disposed on a remote vehicle; and
capturing a field of view image with the video camera.

2. The method of claim 1, further comprising manipulating the video camera field of view through a 360° visual space of a remote vehicle field of action.

3. The method of claim 1, further comprising transmitting the field of view image over a network.

4. The method of claim 1, further comprising transmitting the field of view command over the network.

5. A method for manipulating a video image for a remote vehicle, the method comprising:
capturing a video image from a video camera, the video camera disposed on a remote vehicle;
receiving a field of view command; and
providing a field of view image to a user in accordance with the field of view command.

6. The method of claim 5, further comprising composing the field of view image from the video image in accordance with the field of view command.

7. The method of claim 5, further comprising transmitting the field of view image over a network.

8. The method of claim 5, further comprising transmitting the field of view command over the network.

9. An apparatus for manipulating a field of view of a video image from a remote vehicle, the apparatus comprising:
a remote vehicle;
a video camera disposed on the remote vehicle, the video camera configured to capture a video image of a field of view;
a video camera control module configured to receive a field of view command; and
the video camera control module further configured to manipulate the field of view of the video camera.

10. A system for manipulating a field of view of a video image from a remote vehicle, the system comprising:
a video camera configured to capture a video image, the video camera disposed on a remote vehicle;
a field of view command module configured to transmit a field of view command;
a video camera control module configured to receive a field of view command;
the video camera control module further configured to manipulate the video camera field of view; and
a video transmission module configured to transmit a field of view image.

11. The system of claim 10, wherein the field of view image is transmitted over a network.

12. The system of claim 10, wherein the field of view command is transmitted over the network.

13. A system for manipulating a field of view of a video image for a remote vehicle, the system comprising:
a video camera configured to capture a video image, the video camera disposed on a remote vehicle;
a field of view command module configured to transmit a field of view command;
a field of view control module configured to receive the field of view command; and
a video processing module configured to compose a field of view image from the video image.

14. The system of claim 13, wherein a second field of view image is composed according to a second field of view command.

15. The system of claim 13, wherein the field of view image is transmitted over a network.

16. The system of claim 13, wherein the field of view command is transmitted over the network.

17. An apparatus for manipulating a field of view of a video image from a remote vehicle, the apparatus comprising:
means for transmitting a field of view command;
means for receiving the field of view command;
means for manipulating a video camera field of view according to the field of view command; and
means for transmitting a field of view image.

18. An apparatus for manipulating a field of view of a video image from a remote vehicle, the apparatus comprising:
means for transmitting a video image;
means for transmitting a field of view command;
means for receiving the field of view command; and
means for composing a field of view image from the video image according to the field of view command.

19. A computer readable storage medium comprising computer readable program code for composing a video image according to a field of view command, the program code configured to:
receive a field of view command;
manipulate a field of view of a video camera;
capture a field of view image; and
transmit the field of view image.

20. A computer readable storage medium comprising computer readable program code for composing a video image according to a field of view command, the program code configured to:
receive a field of view command;
receive a video image; and
compose a field of view image from the video image according to the field of view command.
